(19) United States
(12) Patent Application Publication
(10) Pub. No.: US 2018/0100430 A1
(43) Pub. Date: Apr. 12, 2018

(54) SUPERCHARGER HAVING CONSTANT LEAD HELIX ANGLE TIMING GEARS

(71) Applicant: Eaton Corporation, Cleveland, OH (US)

(72) Inventor: Benjamin S. Sheen, Schoolcraft, MI (US)

(73) Assignee: Eaton Corporation, Cleveland, OH (US)

(21) Appl. No.: 15/836,991

(22) Filed: Dec. 11, 2017

Related U.S. Application Data
(63) Continuation of application No. PCT/US2016/036809, filed on Jun. 10, 2016.
(60) Provisional application No. 62/174,287, filed on Jun. 11, 2015.
(60) Provisional application No. 62/341,935, filed on May 26, 2016.

(51) Int. Cl. F02B 39/04; F04C 29/00

(52) U.S. Cl. CPC F02B 39/04; F04C 18/126; F04C 29/0042

(57) ABSTRACT

A supercharger constructed in accordance to one example of the present disclosure includes a housing, a first rotor, a second rotor, a first timing gear, a second timing gear, a first rotor shaft and a second rotor shaft. The first and second rotors are received in cylindrical overlapping chambers of the housing. The first timing gear has first helical teeth. The second timing gear has second helical teeth. The second timing gear is arranged in meshed engagement with the first timing gear such that the second timing gear is driven by the first timing gear. The first rotor shaft supports the first rotor and the first timing gear. The second rotor shaft supports the second rotor and the second timing gear. The first timing gear has a first axial lead. The first rotor has a second axial lead. The first and second axial leads match.

### CROSS-REFERENCE TO RELATED APPLICATIONS

This application is a continuation of International Application No. PCT/US2016/036809 filed Jun. 10, 2016, which claims the benefit of U.S. Patent Application No. 62/174,287 filed on June 11, 2015 and U.S. Patent Application No. 62/341,935 filed on May 26, 2016. The disclosures of the above applications are incorporated herein by reference.

### FIELD

The present disclosure relates generally to superchargers and more particularly to a supercharger that incorporates timing gears having a constant lead helix angle.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, can be driven by meshed timing gears. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine. In some examples, superchargers such as the Roots-type blower can incorporate timing gears in the form of spur gears. Spur gears do not have any helical twist.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A supercharger constructed in accordance to one example of the present disclosure includes a housing, a first rotor, a second rotor, a first timing gear, a second timing gear, a first rotor shaft and a second rotor shaft. The first and second rotors are received in cylindrical overlapping chambers of the housing. The first timing gear has first helical teeth. The second timing gear has second helical teeth. The second timing gear is arranged in meshed engagement with the first timing gear such that the second timing gear is driven by the first timing gear. The first rotor shaft supports the first rotor and the first timing gear. The second rotor shaft supports the second rotor and the second timing gear. The first timing gear has a first axial lead. The first rotor has a second axial lead. The first and second axial leads match.

According to additional features of the present disclosure the second timing gear has the first axial lead. The second rotor has the second axial lead. The first and second timing gears rotate at the same rate as the first and second rotors. Axial movement of the first rotor shaft can cause the first helical teeth on the first timing gear to rotate the second helical teeth on the second timing gear. Axial movement of the second rotor can cause the second helical teeth on the second timing gear to rotate the first helical teeth on the first timing gear. The first and second rotors include coating. Clearances between the first and second rotors are maintained subsequent to one of the first and second rotor shafts moving axially.

According to other features of the present disclosure, the first and second timing gears and the first and second rotors twist at an equivalent rate of angular displacement. The first and second axial leads are equivalent. The first and second axial leads are within five percent (5%) of each other.

A supercharger constructed in accordance to another example of the present disclosure includes a housing, a first rotor, a second rotor, a first timing gear, a second timing gear, a second timing gear, a first rotor shaft, and a second rotor shaft. The first rotor and the second rotor are received in cylindrical overlapping chambers of the housing. The first timing gear has first helical teeth. The second timing gear has second helical teeth. The second timing gear is arranged in meshed engagement with the first timing gear such that the second timing gear is driven by the first timing gear. The first rotor shaft supports the first rotor and the first timing gear. The second rotor shaft supports the second rotor and the second timing gear. The first and second timing gears have a first axial lead. The first and second rotors have a second axial lead. The first and second axial leads are equivalent.

According to additional features, axial movement of the first rotor shaft causes the first helical teeth on the first timing gear to rotate the second helical teeth on the second timing gear. Axial movement of the second rotor shaft can cause the second helical teeth on the second timing gear to rotate the first helical teeth on the first timing gear. The first and second rotors include coating. Clearances between the first and second rotors are maintained subsequent to one of the first and second rotor shafts moving axially. Both the first and second timing gears and the first and second rotors twist at an equivalent rate of angular displacement. The first and second axial leads can be within five percent (5%) of each other.

A supercharger constructed in accordance to another example of the present disclosure includes a housing, a first rotor, a second rotor, a first timing gear, a second timing gear, a second timing gear, a first rotor shaft, and a second rotor shaft. The first rotor and the second rotor are received in cylindrical overlapping chambers of the housing. The first timing gear has first helical teeth. The second timing gear has second helical teeth. The second timing gear is arranged in meshed engagement with the first timing gear such that the second timing gear is driven by the first timing gear. The first rotor shaft supports the first rotor and the first timing gear. The second rotor shaft supports the second rotor and the second timing gear. Both the first and second timing gears and the first and second rotors twist at an equivalent rate of angular displacement.

According to further features of the present disclosure, the first and second timing gears have a first axial lead. The first and second rotors have a second axial lead. The first and second axial leads are equivalent. The first and second axial leads can be within five percent (5%) of each other. Axial movement of the first rotor shaft causes the first helical teeth on the first timing gear to rotate the second helical teeth on the second timing gear. Axial movement of the second rotor shaft can cause the second helical teeth on the second timing gear to rotate the first helical teeth on the first timing gear. The first and second timing gears rotate at the same rate as the first and second rotors.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is a front perspective view of a pair of rotor shafts and corresponding timing gears constructed in accordance to one example of the present disclosure; and

FIG. 3 is a front perspective view of a timing gear shown in FIG. 2;

FIG. 4 is a rear perspective view of a timing gear shown in FIG. 2; and

FIG. 5 is a mathematical representation of a lead.

### DETAILED DESCRIPTION

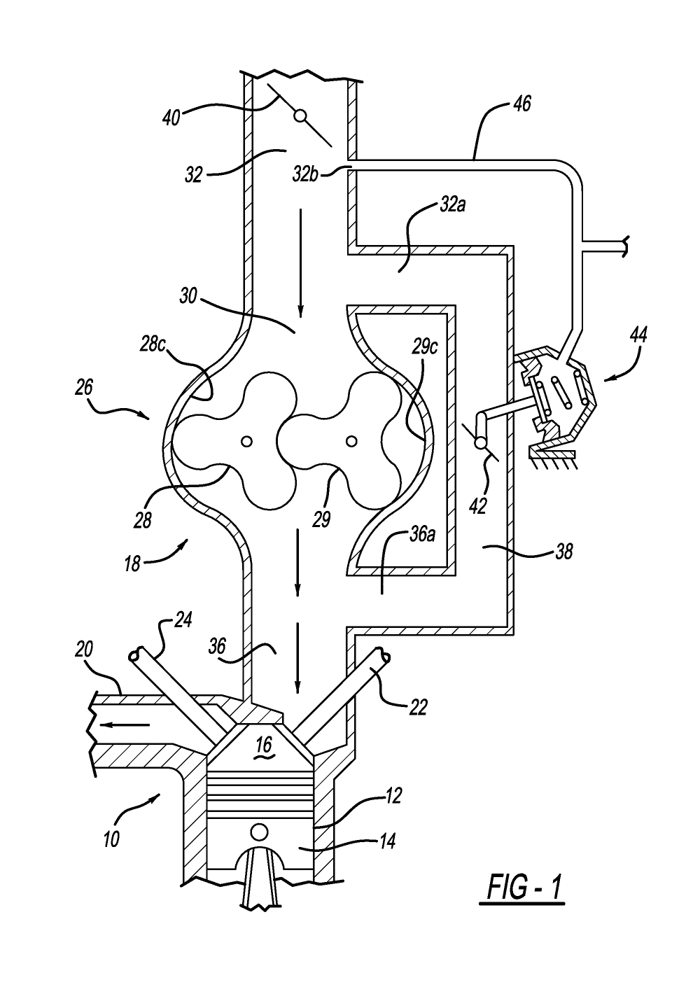

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos, 5,078,583 and 5,893,355, which are expressly incorporated herein by reference. The blower 26 includes a pair of rotors 28 and 29, each of which includes a plurality of meshed lobes. The rotors 28 and 29 are disposed in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The supercharger 26 can include an inlet port 30 which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

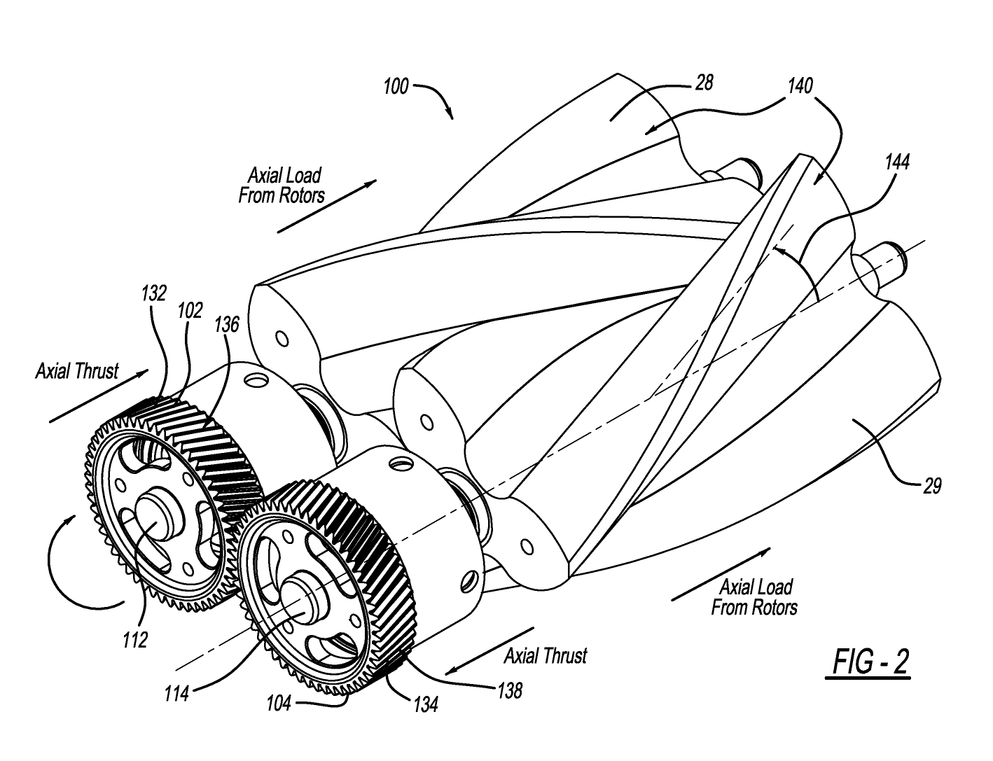

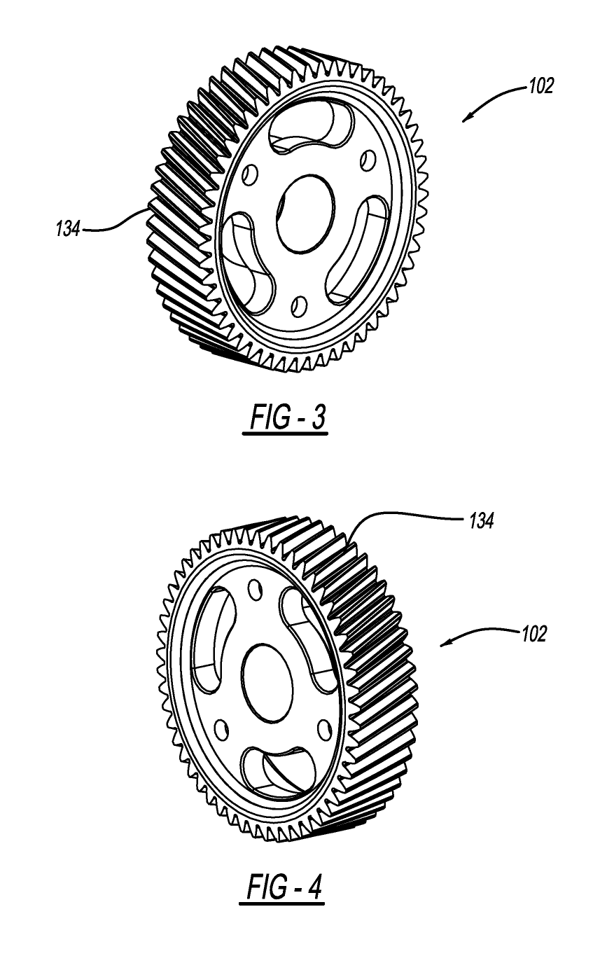

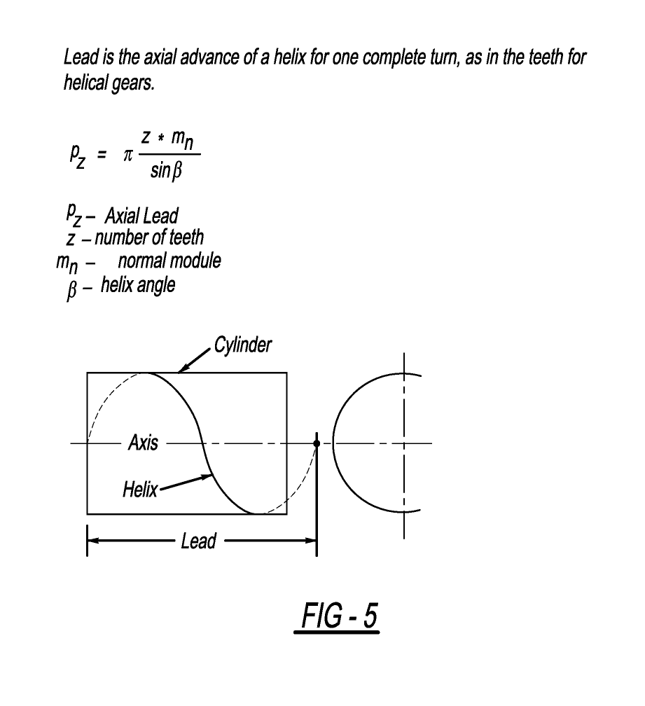

With particular reference now to FIG. 2, additional features of the supercharger 26 will be described in greater detail. The supercharger 26 according to the present disclosure includes a rotor assembly 100 that includes a first and second timing gear 102 and 104 that are mounted on the end of respective rotor shafts 112 and 114. In the example shown, the first timing gear 102 is a drive gear while the second timing gear 104 is a driven gear. The first and second timing gears 102 and 104 incorporate helical teeth 132 and 134, respectively. The helical teeth 132 and 134 are in meshed engagement. The second rotor shaft 114 is therefore driven as a result of the meshed engagement of the helical teeth 132 and 134 of the respective timing gears 102 and 104.

According to the present disclosure, the timing gears 102 and 104 twist (rotate) at the same rate as the rotors 28 and 29. Explained further, the first and second timing gears 102 and 104 have a helix angle (or lead) 136 and 138, respectively. The first and second rotors 28 and 29 have a helix angle (or lead) 142 and 144, respectively. The axial lead 136 and 138 of the timing gears 102 and 104 match the axial lead (identified at reference 144) of the rotors 28 and 29. As used herein “match” means equivalent to or within five percent (5%) of each other. Any thrust loads and axial movement of the rotor shafts 112 and 114 will not change the timing of the rotor assembly 100. In this regard, the rotor shafts 112 and 114 are precluded from rotating. As a result, the side clearances between the rotors 28 and 29 are maintained. Therefore, coating 140 on the rotors 28 and 29 will be maintained improving efficiency.

Further, the configuration of the rotor assembly 100 maintains the timing of the rotating rotor group independent of axial movement of the rotor shafts 112 and 114. Both the first and second timing gears and the rotors 28 and 29 twist at the same exact rate of angular displacement. When the timing gears 102 and 104 are synchronized with the rotors 28 and 29, as the rotor shafts 112 and 114 move axially (such as due to bearing internal clearances), the timing gears 102 and 104 rotate the rotor shafts 112 and 114 at the same twist as the rotors 28 and 29. In addition, any thermal growth such as axially along the rotor shafts 112 and 114 will also occur at the same rate. In this regard, the clearances (gap or channel) between the rotors 28 and 29 can be maintained without abrading and/or compromising the rotor coating and ultimately compromising efficiency. In another advantage the helical timing gears 102 and 104 reduces operating noise of the supercharger 26 over prior art configurations that incorporate conventional spur gears.

In one configuration, positive torque is transmitted from an internal combustion engine (of the periodic combustion type) to the input shaft by any suitable drive means, such as a belt and pulley drive system. Torque is transmitted from the input shaft (not specifically shown) to the rotor shaft assembly 100 through an isolator assembly (not shown). The isolator assembly can provide torsional and axial damping and can further account for misalignment between the input shaft and the rotor shaft 112. When the engine is driving the timing gears 102 and 104, and the blower rotors 28 and 29, such is considered to be transmission of positive torque. On the other hand, whenever the momentum of the rotors 28 and 29 overruns the input from the input shaft, such is considered to be the transmission of negative torque.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A supercharger comprising:
a housing;
a first rotor and a second rotor received in cylindrical overlapping chambers of the housing;
a first timing gear having first helical teeth;
a second timing gear having second helical teeth, the second timing gear arranged in meshed engagement with the first timing gear such that the second timing gear is driven by the first timing gear;
a first rotor shaft that supports the first rotor and the first timing gear;
a second rotor shaft that supports the second rotor and the second timing gear;
wherein the first timing gear has a first axial lead and the first rotor has a second axial lead, wherein the first and second axial leads match.

2. The supercharger of claim 1 wherein the second timing gear has the first axial lead and the second rotor has the second axial lead.

3. The supercharger of claim 2 wherein the first and second timing gears rotate at the same rate as the first and second rotors.

4. The supercharger of claim 3 wherein axial movement of the first rotor shaft causes the first helical teeth on the first timing gear to rotate the second helical teeth on the second timing gear.

5. The supercharger of claim 3 wherein axial movement of the second rotor shaft causes the second helical teeth on the second timing gear to rotate the first helical teeth on the first timing gear.

6. The supercharger of claim 1 wherein the first and second rotors include coating and wherein clearances between the first and second rotors are maintained subsequent to one of the first and second rotor shafts moving axially.

7. The supercharger of claim 2 wherein both the first and second timing gears and the first and second rotors twist at an equivalent rate of angular displacement

8. The supercharger of claim 1 wherein the first and second axial leads are equivalent.

9. The supercharger of claim 8 wherein the first and second axial leads are within five percent (5%) of each other.

10. A supercharger comprising:
a housing;
a first rotor and a second rotor received in cylindrical overlapping chambers of the housing;
a first timing gear having first helical teeth;
a second timing gear having second helical teeth, the second timing gear arranged in meshed engagement with the first timing gear such that the second timing gear is driven by the first timing gear;
a first rotor shaft that supports the first rotor and the first timing gear;
a second rotor shaft that supports the second rotor and the second timing gear;
wherein the first and second timing gears have a first axial lead and the first and second rotors have a second axial lead, wherein the first and second axial leads are equivalent.

11. The supercharger of claim 10 wherein axial movement of the first rotor shaft causes the first helical teeth on the first timing gear to rotate the second helical teeth on the second timing gear.

12. The supercharger of claim 11 wherein axial movement of the second rotor shaft causes the second helical teeth on the second timing gear to rotate the first helical teeth on the first timing gear.

13. The supercharger of claim 10 wherein the first and second rotors include coating and wherein clearances between the first and second rotors are maintained subsequent to one of the first and second rotor shafts moving axially.

14. The supercharger of claim 10 wherein both the first and second timing gears and the first and second rotors twist at an equivalent rate of angular displacement.

15. The supercharger of claim 10 wherein the first and second axial leads are within five percent (5%) of each other.

16. A supercharger comprising:
a housing;
a first rotor and a second rotor received in cylindrical overlapping chambers of the housing;
a first timing gear having first helical teeth;
a second timing gear having second helical teeth, the second timing gear arranged in meshed engagement with the first timing gear such that the second timing gear is driven by the first timing gear;
a first rotor shaft that supports the first rotor and the first timing gear; and
a second rotor shaft that supports the second rotor and the second timing gear;
wherein both the first and second timing gears and the first and second rotors twist at an equivalent rate of angular displacement.

17. The supercharger of claim 16 wherein the first and second timing gears have a first axial lead and the first and second rotors have a second axial lead, wherein the first and second axial leads are equivalent.

18. The supercharger of claim 16 wherein the first and second axial leads are within five percent (5%) of each other.

19. The supercharger of claim 16 wherein axial movement of the first rotor shaft causes the first helical teeth on the first timing gear to rotate the second helical teeth on the second timing gear and wherein axial movement of the second rotor shaft causes the second helical teeth on the second timing gear to rotate the first helical teeth on the first timing gear.

20. The supercharger of claim 16 wherein the first and second timing gears rotate at the same rate as the first and second rotors.
